(19) United States
(12) Patent Application Publication
(10) Pub. No.: US 2003/0008209 A1
(43) Pub. Date: Jan. 9, 2003

(54) Cathode coating dispersion

(76) Inventors: Marufur Rahim, Fort Gratiot, MI (US); Surendra Kadakia, Clinton Township, MI (US)

Correspondence Address: Charles W. Almer, NATIONAL STARCH AND CHEMICAL COMPANY, 10 Finderne Avenue, Bridgewater, NJ, 08807-0500, US

(21) Appl. No.: 09/888,306

(22) Filed: Jun. 22, 2001

(51) Int. Cl. H01M 2/02; H01G 9/10

(52) U.S. Cl. 429/176; 429/12; 361/519

(57) ABSTRACT

This invention relates to a graphite and/or carbon black-containing cathode coating dispersion which is suitable for battery production. The dispersion is water and alkali resistant and also electrically conductive when coated on cathode surfaces. The dispersion is a one pot thermoset water-based system which contains at least two binders which are epoxy ester and styrene acrylic, stryrene butadiene or butadiene acrylonitrile. The formulation containing butadiene acrylonitrile is also suitable as acid resistance coating. The dispersion also contains at least one crosslinker such as melamine and or carbodiimide. The crosslinking is accelerated by using acid catalyst in the dispersion.

### FIELD OF THE INVENTION

This invention relates to one pot high temperature curable thermoset cathode coating dispersions. The formulations contain graphite and/or carbon black, acrylic resin or butadiene acrylonitrile or styrene butadiene or epoxy and/or epoxy ester. The coatings are cured with appropriate crosslinkers such as melamine and/or phenolic resin and/or carbodiimide and acid catalyst. These coatings are suitable for use in batteries, fuel cells, capacitors and other energy storage devices.

### BACKGROUND OF THE INVENTION

Alkali battery dry cells are manufactured by pre-forming a steel can with a nickel plating inside the can. The cathode, a compressed mixture of manganese dioxide, carbon and possibly other additives is positioned inside the can in the form of a hollow cylinder which is in close contact with the can inner surface. Alternatively, rings of cathode materials can be formed outside the cell and then pushed into the can. The inside of the can is treated with a conductive dispersion which is placed between the inside surface of the can and the cathode mixture in order to improve the electrical contact between the can and the cathode mixture and to prevent corrosion of the nickel layer and the can from the electrolytes.

In the past various emulsions have been utilized in an attempt to maximize electrical contact and prevent corrosion in batteries. These emulsions generally contain graphite and/or carbon black in combination with a binder. For example, U.S. Pat. No. 4,810,600 utilizes a dispersion containing graphite and/or carbon black in combination with a binder of a) vinyl acetate and ethylene, b) vinyl acetate and vinyl chloride, c) styrene and butadiene, or d) vinyl acetate, vinyl chloride and ethylene. In addition, other dispersions have been utilized containing binders of aromatic polyurethane, styrene acrylic, aliphatic polyester polyurethane, vinyl acetate acrylic, aliphatic polycarbonate urethane and fluoropolymer. All the above dispersions were used as a thermoplast which requires no crosslinker during the cure. After final cure on nickel plated steel all of these various dispersions exhibited some form of failure when subjected to high concentrations of potassium hydroxide. The dispersions in some cases showed high electrical resistance after the KOH test as opposed to before the test and in some cases the binders either became soft or lost adhesion when sprayed on the nickel plated panel, dried at 80° C. for 20 minutes and then immersed in 40% KOH solution for 72 hours at 80° C. One of the main reasons for the softness is due to lower Tg (glass transition temperature) of the binder. Harder coatings which require higher Tg and will not soften at higher temperature, can be achieved by a crosslinking reaction with other resins.

The objective of the present invention is to provide one component, heat activated crosslinking conductive coatings for use in batteries, fuel cell, capacitor or other energy storage devices. The dispersion is made of graphite and or carbon black, binders, crosslinkers and a catalyst. The coatings form a stable electrically conducting cathode layer which in turn improves the storage and discharge properties of the energy device. The improved properties of the coating also include the strong adherence of the coating with the cathode surface when it is subjected to potassium hydroxide and/or elevated temperatures. It is a further objective to provide a dispersion which may be utilized on the bipolar plates of a fuel cell or as a current collector for electrodes used in an ultracapacitor.

### SUMMARY OF THE INVENTION

The dispersion is a one pot system comprised of styrene acrylic and epoxy ester in which melamine and/or carbodiimide are added as cross linkers. The formulation may also contain a blocked acid to catalyze the cross linking reaction. A similar dispersion is also formulated by using butadiene acrylonitrile or styrene butadiene and epoxy ester which also include the above cross linkers and catalysts. Further, a dispersion may also consist of epoxy and/or epoxy ester and acid catalysts, phenolic resin and/or melamine as crosslinkers. These one pot systems have shown excellent resistance to alkali at higher temperature and generate good conductivity when applied on a nickel plated steel. The formulation containing butadiene acrylonitrile has also shown good acid resistance as well. Consequently, these coatings can be used as a cathode coating for energy storage devices such as alkaline batteries that will generate suitable conductivities as well as an excellent resistance to chemicals in the alkaline batteries, fuel cells and capacitors and other energy storage devices.

### DETAILED DESCRIPTION OF THE INVENTION

The dispersion of the present invention is comprised of a graphite and/or carbon black with at least two kinds of resins which contain carboxylic functionality for cross linking reactions. Similarly, a dispersion of the second kind is formulated by using epoxy and phenolic resin and or melamine. The hydroxyl group of epoxy crosslinks with melamine and the epoxy group crosslinks with phenolic resin. The cross linking reactions also occur only after applying higher temperature for a period of time. The cross linking reactions generate a coating which is very resistant to alkaline and acid environment and produces a good electrically conducting layer.

The graphite dispersion is specifically developed as a cathode current collector for alkaline batteries. This dispersion serves as a coating on a current collector and prevents the corrosion of the electrode from the corrosive chemical environment inside the alkaline batteries. The dispersion, specifically the formulation containing butadiene-acrylonitrile or epoxy as a binder, is not only alkaline resistant but also resistant to acidic environments. Consequently, the coating can be used as well in a fuel cell where higher resistance of the current collector coating is desired to the bipolar electrodes.

These dispersions are primarily utilized for coating a cathode holder or battery can. Along the same line these dispersions are also suitable for application as current collector coatings on electrodes of an ultracapacitor. These coatings form the connecting layer that improves the electrical contact between the electrode and the electrolyte, which may be aqueous or non-aqueous in nature. Preferred graphites for use in the dispersion are natural or synthetic graphites of high purity and high crystallinity. In the dispersion mixture, the electrically conductive graphite is used in the amount of about 30-90% by weight of the total solid. To prepare a proper dispersion, demineralized water is used as a dispersing media. Also, to obtain problem free coatings the following additives are added. For example, defoamers, preservatives, surface agent and/or dispersing agents may be utilized. Defoamers which may be utilized include BYK 022, BYK 019, BYK 24 (BYK-Chemie), DF 37, DF-40, DF 120, DF 70, DF-75, DF-58, DF 60, DF-62, DF 66, DF 574, DF 696 (Air Products & Chemicals, Inc.), Nalco 2300, Nalco 2305, Nalco 2302 (Rohm & Haas Co.), Triton CF-32 (BASF Corp.), L-62 (Witco), Coatsil 1300 (Condea Vista) and Alfol 8 alcohol. Preservatives which may be utilized include Busan 85, Busan 2024, Busan 1024 (Buckman Laboratories), Hyamine 10-X, Hyamine 2389 (Rohm & Haas Co.), Promexal X50 (Zeneca), Parmetol DF 18 (S&M Special Additives), Kathon 886 (Rohm & Haas Co.) and Nuosept 101 (Creanova). Dispersing agents which may be utilized include, Busperse 229 (Buckman Laboratories), Tamol N, Tamol 731, Tamol 850, Tamol SN Rohm & Haas Co.), Daxad 30-30, Daxad 11, Daxad 15, Daxad 19 (W&R Grace Co.), CT-136, CT 141, CT 151, CT 161, CT 171 (Air Products & Chemicals, Inc.), Disperbyk 182, Disperbyk 190 and Disperbyk 185 (BYK-Chemie). Wetting agents which may be employed include Tween 20 (Spectrum Quality Products), Orotan and Silwet L-7068 (Witco). Surfactants which may be utilized include 104A, 104B, 104DPM, 104E, 104H, 104NP and 104PA (Air Products & Chemicals, Inc.), and BYK 333.

In a preferred embodiment, the additives comprise from about 0.01 to about 5% of the total formulation weight. In an especially preferred embodiment, a wetting agent may also be added to the mixture.

In order to form a suitable resin dispersion the graphite and or carbon black are mixed with acrylic latex and epoxy ester. The acrylic latex in this application contains styrene and acrylic or butadiene resin in the polymeric backbone of the binder system. The epoxy ester preferably has an acid number of 10-100. The ratio of acrylic to styrene or butadiene resin is preferably in the range of about 0.01 to about 9. Similarly, a second dispersion is developed for the same application which contains graphite and or carbon black in combination with butadiene acrylonitrile and epoxy ester. All of the above binders contain carboxylic functionality to provide the crossliking reaction with melamine and or carbodiimide. A third dispersion is made with graphite and/or carbon black which contains epoxy and epoxy ester. In addition, the dispersion also contains melamine and phenolic resin as crosslinkers. In order to achieve proper conductivity for the desired application, it is necessary to prepare the mixture with the proper ratio of graphite and/or carbon black to binders. For example, for use with battery cans the proper ratio of graphite and/or carbon black to binder is in the range of about 1 to 6, with a preferred range of about 1 to 4. The overall water content of the dispersion is preferably in the range of about 30-90% by weight and the graphite and/or carbon black mixture is preferably about 10-60% by dry mass weight.

A stable dispersion is formed in the presence of the proper additives and the binders. The viscosity ranges from 50-1200 mPa-sec. For proper curing the dispersion also contains one or more crosslinkers and an acid catalyst. The preferred crosslinkers are melamine, carbodiimide, phenolic or mixtures thereof. The acid catalyst is used to catalyze the reaction between the melamine and the binders. A curing agent may be utilized comprising a melamine and preferably a partially alkylated melamine with a higher imino group

Preferred crosslinkers include fully or partially alkylated melamine. Available crosslinkers include C-327, C-324, C-325, C-1158, C-323, C-303, C-350, C-370, C-385, C-1123 (CYTEC) and Ucarlink XL 29SE (Union Carbide).

The reaction between the carboxylic functionality and melamine is catalyzed by sulfonic acid of various types including blocked sulfonic acids. More specifically the amine salt of para-Toluene Sulfonic Acid (p-TSA), such as BYK-Catalyst 450, BYK-Catalyst 460 (BYK Chemie), Nacure 2107 and Nacure 2500, Nacure 49-110, (King Industries, Inc.), or epoxy blocked Dinonylnaphthalene Sulfonic acid, such as Nacure 1419 (King Industries Inc.), CyCat 296-9 catalyst (Cytec) or Nacure 49-110.

Preferred phenolic resins include Phenodur PR 308, Phenodur PR 307, Phenodur VPW 1942/52WA (Solutia).

Following its preparation, the coating is then applied to the surface via pouring, brushing, spraying or dipping and cured at elevated temperature. The water may be removed by allowing it to dry, by warming or by application of a vacuum. A preferred curing temperature is within the range of about 100° C.- to about 250° C. Depending upon the chosen curing process, the time of curing ranges from 15 seconds to 16 minutes. The rate of curing can be controlled by changing the amount of crosslinkers and the catalysts. After curing, a mechanically and chemically resistant, electrolyte insoluble protective film remains on the surface. The resistivity of the resulting coating is about 5-100 ohm per square. The resistance of the protective coating formed by the dispersion is not more than twice the initial value after the coating has been exposed to a 40% KOH solution for a period of 72 hours at 80° C. The amount of coating to be applied is selected so that the film thickness of the resulting protective film after evaporation of the water is preferably about 5-200 microns and most preferably about 20-100 microns. A uniform thickness is obtained via the pseudoplastic and thixotropic properties of the dispersion.

The invention may be better understood by reference to the following examples which are intended for the purpose of illustration and are not to be construed as in any way limiting the scope of the present invention.

### EXAMPLES

Two formulations were prepared by the following steps.

1. Load 90% demineralized water, dispersant and celluose into ring mill. Agitate 5-10 minutes or until dissolved.

2. Add defoamer, carbon black and graphite powder

3. Circulate mill for 5 hours or until minimum Hegman of 5.0 is achieved.

4. Make letdown as follows: Premix epoxy ester and DMEA before adding to the batch then let it mix for 10 minutes. Then add the latex and melamine and or carbodiimide and let it mix for 15-20 minutes. Before adding the catalyst, the batch temperature is adjusted to about 32°-35° C. and then the catalyst is added. The viscosity is adjusted with water and PH with DMEA and or ammonia.

The components of each formulation are set out in Example 1 and 2.

EXAMPLE 1

| | |
|---|---|
| Carbon black | 3.030 grams |
| (Vulcan XC-72 pellets) | |
| Cellulose | 0.69 |
| Dimethylethanolamine | 0.31 |
| Defoamer | 0.16 |
| Dispersion Agent | 0.77 |
| Demineralized Water | 49.92 |
| Synthetic Graphite | 20.63 |
| (graphite 39 powder) | |
| Chempol 010-0453 | 2.470 |
| Neocryl A-662 | 17.28 |
| Cymel 323 | 4.63 |
| Nacure X49-110 | 0.25 |
| | 100 grams |

EXAMPLE 2

| | |
|---|---|
| Carbon black | 3.030 grams |
| (Vulcan XC-72 pellets) | |
| Cellulose | 0.69 |
| Dimethylethanolamine | 0.25 |
| Defoamer | 0.16 |
| Dispersion Agent | 0.77 |
| Demineralized Water | 45.64 |
| Synthetic Graphite | 20.63 |
| (graphite 39 powder) | |
| Chempol 010-0453 | 2.470 |
| Tylac 97767 | 22.74 |
| Cymel 323 | 3.86 |
| Nacure X49-110 | 0.25 |
| XL 29SE | 1.23 |
| | 100 grams |

EXAMPLE 3

| | |
|---|---|
| Carbon black | 3.030 grams |
| (Vulcan XC-72 pellets) | |
| Cellulose | 0.69 |
| Dimethylethanolamine | 0.48 |
| Defoamer | 0.16 |
| Dispersion Agent | 0.77 |
| Demineralized Water | 53.07 |
| Synthetic Graphite | 20.63 |
| (graphite 39 powder) | |
| Chempol 010-0453 | 2.470 |
| Phenodur VPW 1942/52WA | 13.82 |
| Cymel 323 | 4.63 |
| Nacure X49-110 | 0.25 |
| | 100 g |

The resulting coatings from Examples 1 and 2 were sprayed on nickel-plated panels and cured at 150° C. for 3 minutes or 1 minute at 205° C. The coating from Example 3 were baked at 205° C. for 3 minutes. The nickel-plated panel was then placed in a 40% KOH solution for 72 hours at 80° C. The panels were then removed from the solution, washed with running water and then dried in an oven for 30 minutes at 60° C. A tape test was performed wherein Scotch brand tape was firmly pressed onto each sample and then slowly removed at a 90 degree angle. Excellent adhesion was shown by each sample in that none of the coating was removed via the tape test.

While the invention has been described with particular reference to certain embodiments thereof, it will be understood that changes and modifications may be made by those of ordinary skill within the scope and spirit of the following claims.

What is claimed is:

1. A coating dispersion for coating an energy storage device comprised of graphite, carbon black or a mixture thereof, a binder, and one or more cross-linking agents, wherein the coating dispersion is applied as a homogenous aqueous dispersion which forms a protective film on the energy storage device, and wherein the binders are selected from the group comprising styrene acrylic, butadiene acrylonitrile, butadiene styrene, epoxy and epoxy ester.

2. The coating dispersion of claim 1, wherein the cross-linking agent comprises melamine, carbodiimide, phenolic and acid catalyst, or mixtures thereof.

3. The coating dispersion of claim 1, wherein the ratio of the graphite, carbon black or mixture thereof to binder is in the range of about 1 to 6.

4. The coating dispersion of claim 3, wherein the ratio of the graphite, carbon black or mixture thereof to binder is in the range of about 1 to 4.

5. The coating dispersion of claim 3, wherein the dispersion has a water content between about 30 to about 90% by weight.

6. The coating dispersion of claim 5, wherein the graphite, carbon black or mixture thereof content contains a dry mass between about 10-60% by weight.

7. The coating dispersion of claim 3, wherein the dispersion additionally contains one or more defoamers, preservatives, dispersing agents, wetting agents, surfactants or mixtures thereof.

8. The coating dispersion of claim 7, wherein the one or more defoamers, preservatives, dispersing agents, wetting agents, surfactants or mixtures thereof comprise between about 0.05 to about 5% by weight.

9. The coating dispersion of claim 8, wherein the dispersion contains about 0.05 to about 5% by weight of a wetting agent.

10. The coating dispersion of claim 7, wherein the dispersion contains about 0.05 to about 5% of a surfactant.

11. The coating dispersion of claim 6, wherein the curing agent is a partially alkylated melamine with higher imino group.

12. The coating dispersion of claim 10 comprising from about 0 to about 5% by weight of second cross-linking agent.

13. The coating dispersion of claim 12, wherein the second cross-linking agent is carbodiimide.

14. The coating dispersion of claim 11 further comprising a catalyst selected from the group consisting of amine salt of para-Toluene Sulfonic Acid, epoxy blocked Dinonylnaphthalene Sulfonic acid, or mixtures thereof.

15. The coating dispersion of claim 14, wherein the dispersion has a viscosity of between about 50 to about 1200 cps.

16. The coating dispersion of claim 15, wherein the binder contains an epoxy ester of acid number of 10-100.

17. The coating dispersion of claim 15, wherein the dispersion contains styrene and acrylic having a styrene/acrylic ratio in the range of about 0.01 to about 9.

18. The coating dispersion of claim 15, wherein the dispersion contains styrene butadiene resin and acrylic having a styrene/butadiene ratio in the range of about 0.1 to about 9.

19. The coating dispersion of claim 15 wherein the dispersion contains butadiene acrylonitrile having a ratio in the range of about 0.01 to about 9.

20. The coating dispersion in claim 13 is cured at temperature ranging from about 100° C. to about 250° C. for about 15 seconds to about 16 minutes.

21. The coating dispersion of claim 1, wherein the dispersion forms a protective film having a conductivity in the range of about 5 to 100 ohm per square.

22. The coating dispersion of claim 1, wherein the resistance of a protective film formed by the coating dispersion is not more than twice the initial value after exposure of the conductive film to a 40% KOH solution for a period of 72 hours at 80° C.

23. The coating dispersion of claim 1, wherein the energy storage device is a battery, fuel cell or capacitor.

24. An energy storage device containing an electrically conductive protective film deposited from the coating dispersion of claim 1, wherein the conductive protective film is in the range of about 5 to about 200 microns thick.

25. An alkaline battery containing an electrically conductive protective film deposited from the coating dispersion of claim 1, wherein the conductive protective film is in the range of about 20 to about 100 microns thick.

26. A fuel cell containing an electrically conductive protective film deposited from the coating dispersion of claim 1, wherein the conductive protective film is in the range of about 5 to 200 microns thick.

27. A fuel cell containing an electrically conductive protective film deposited from the coating dispersion of claim 1, wherein the conductive protective film is in the range of about 20 to about 100 microns thick.

28. A capacitor containing an electrically conductive protective film deposited from the coating dispersion of claim 1, wherein the conductive protective film is in the range of about 5 to about 200 microns thick.

29. A capacitor containing an electrically conductive protective film deposited from the coating dispersion of claim 1, wherein the conductive protective film is in the range of about 20 to about 100 microns thick.
